(19) United States
(12) Patent Application Publication
(10) Pub. No.: US 2019/0053661 A1
(43) Pub. Date: Feb. 21, 2019

(54) BARBEQUE CONSTRUCTION KIT

(71) Applicant: Jan Daniël VAN DER MERWE, Boksburg (ZA)

(72) Inventor: Jan Daniël VAN DER MERWE, Boksburg (ZA)

(21) Appl. No.: 15/787,845

(22) Filed: Oct. 19, 2017

(30) Foreign Application Priority Data
Aug. 15, 2017 (ZA) 2017/05510

(51) Int. Cl. A47J 37/04; A47J 37/07

(52) U.S. Cl. CPC A47J 37/041; A47J 37/0745

(57) ABSTRACT

The invention relates to a barbeque construction kit. The kit includes a frame for placing over a heat source and a manual grid flip-over device which is mountable onto the frame. The kit also includes a rotisserie motor which is mountable onto the frame. The kit further includes at least one cooking accessory attachable to any one or both of the manual grid flop-over device and rotisserie motor.

### FIELD OF THE INVENTION

This invention relates to a device for cooking food over a heated source. In particular the invention relates to a barbeque construction kit.

### BACKGROUND INFORMATION

There are various ways to cook meat over a heat source and different techniques which can be applied to ensure the meat is cooked or roasted to a person's satisfaction. One such method involves cooking meat over an open flame using a grill, where meat is either placed on top of a cooking grid over a fire or is placed inside a grill basket which is held over the fire and turned intermittently.

Another common method of cooking meat is the use of a rotisserie in which meat is rotated on a spit over a heat source. There are two styles, horizontal and vertical, the former being mountable over a grill. In the case of the horizontal rotisserie, once the meat has been skewered by the spit and placed over coals/open fire, a drive mechanism rotates the spit at a certain speed so that the meat is evenly cooked in its own juices.

Several types of devices are available on the market to facilitate cooking of meat on an open fire, but such devices are often bulky and cannot be used in different configurations.

It is an object of the invention to improve the existing cooking devices of which the inventor is aware.

In this specification the term “barbeque” refers to cooking equipment used for outdoor grilling, and includes braai apparatus' and the like.

### SUMMARY OF THE INVENTION

Broadly according to a first aspect of the invention there is provided a barbeque construction kit, which includes:

a frame for placing over a heat source;

a manual grid flip-over device mountable onto the frame;

a rotisserie motor mountable onto the frame; and

at least one cooking accessory attachable to any one or both of the manual grid flip-over device and rotisserie motor.

The frame may be shaped and dimensioned to be used in combination with an existing barbeque.

The frame may include a main frame which has at least a pair of spaced apart horizontal support bars. In one embodiment, the main frame may be in the form of a rectangular main frame, two opposed sides of the rectangular main frame defining the horizontal support bars. The rectangular main frame may be made up of modular frame components, such that the frame can be disassembled for storage. In another embodiment, the frame may be in the form of a circular frame, having two parallel spaced bars mounted on or in the circular frame defining the support bars. The circular frame may be shaped and dimensioned to fit a kettle barbeque, a rounded barbeque or the like.

The frame may further include supporting legs attachable to a bottom of the main frame.

The at least one cooking accessory may be in the form of any one or more of: a clamping grid, a rotisserie spit, a grid basket or the like. Preferably the barbeque construction kit will include at least two cooking accessories which can be used interchangeably to construct a barbeque suited for a specific cooking purpose.

The frame may further include upright supports, extending upwardly from the support bars of the main frame. In particular, the frame may include a first and second pair of upright supports, each pair includes two supports positioned across from each other on opposed sides of the main frame. The first pair of upright supports may be positioned centrally on the support bars. The second pair of upright supports may be positioned off-centre between the first pair of upright supports and an end of the support bars, on opposed sides of the main frame.

The main frame may further include a pair of fastening formations centrally each of the support bars. The fastening formations may be in the form of apertures through the support bars, for receiving a bolt or the like.

The manual grid flip-over device may include a pair of pivot arms, one end of each pivot arm being pivotably connectable to the fastening formations on the main frame and their opposed ends connectable to ends of the cooking accessory. The manual grid flip-over device may further include a handle. The handle may be substantially U-shaped having a rear elongate bar and two side bars. The rear elongate bar may be matched in length to the main frame side. The two side bars may be V-shaped. The handle may include two pairs of attachment formations, each pair including two attachment formations aligned with each other, on each of the side bars.

The handle may be shaped and dimensioned to fit under a dome shaped lid when the frame is fitted to the kettle barbeque. In such an embodiment, the handle may include a slightly curved elongate bar and two straight side bars.

The first pair of attachment formations may be positioned at ends of the side bars and attachable to ends of the cooking accessory. The handle may include connection spacers for connecting the first pair of attachment formations to the cooking accessory. In use, when the manual grid flip-over device is connected to the frame, the connection spacers rest on the first pair of upright supports of the main frame.

The second pair of attachment formations are positioned at the bends of the V-shaped side bars and attachable to the second pair of upright supports of the main frame. In use, a user presses the handle down and the pivot arms move either forwardly or rearward to flip the cooking accessory over.

The frame may also include support extenders. The support extenders may be attachable to two or more of the upright supports of the frame. The support extenders may be in the form of shafts slidably receivable onto the upright supports of the frame. The support extenders may include adjustment means. The adjustment means may be in the form of reversible fasteners, such that the height of the support extenders above the main frame may be adjusted. The reversible fasteners may be tightened or loosened on the upright supports. The reversible fasteners may be in the form of wing nut bolts or the like.

In particular, two support extenders may be attachable to the first pair of upright supports of the main frame. The support extenders may consist of a first support extender in the form of a motor mounting bracket and a second support extender in the form of a V-shape rest.

The rotisserie motor may be mountable onto the motor mounting bracket. The motor may be in the form of a battery powered motor, an electric motor or the like.

The cooking accessory may include a drive end shaped and dimensioned to be received within the rotisserie motor, such that the cooking accessory is driven by the motor, in particular, rotated by the motor.

The drive end of the cooking accessory may be attachable to the rotisserie motor and an opposed end may rest on the V-shaped rest.

The supporting legs may be displaceable between a first and second position. In the first position, the support legs may extend downwards from the main frame to support the frame over a heat source. In the second position, the supporting legs may extend horizontally alongside the main frame to place the frame directly onto the heated source or an existing grid.

The clamping grid may be in the form of a shallow grid receptacle and a displaceable planar grid, the planar grid being adjustable to clamp varying sized portions of food to be cooked over the heat source within the shallow grid receptacle. The planar grid may include securing means for securing the planar grid to the shallow grid receptacle. The securing means may be in the form of latches, clips, or the like.

The rotisserie spit may be in the form of an elongate rod having adjustable spit forks for receiving varying sized portions of food to be cooked over the heat source.

The grid basket may be in the form of a large grid receptacle having one or more displaceable lids, the receptacle being shaped and dimensioned to receive larger portions of food to be cooked over the heat source. The one or more displaceable lids may be adjustable to balance the weight of food within the grid basket. The displaceable lids may include fastening means for enclosing food within the receptacle when it is in use. The fastening means may be in the form of latches, clips or the like.

In one configuration, when the clamping grid is to be used, the manual grid flip-over device may be mounted onto the frame and the clamping grid mounted onto the flip-over device.

In another configuration, when the rotisserie motor is to be used, the support extenders may be attached to the frame and the rotisserie motor mounted onto the motor mounting bracket, the drive end of a cooking accessory being attached to the rotisserie motor and the opposed end being supported by the V-shaped rest. In this configuration, the cooking accessory may be interchangeable between the clamping grid, rotisserie spit and grid basket.

The invention is now described, by way of non-limiting example, with reference to the accompanying drawings:

### FIGURE(S)

In the figure(s):

FIG. 1 shows a three dimensional view of a barbeque construction kit in one configuration, where a clamping grid is attached to a manual grid flip-over device mounted to a rectangular main frame for flipping the clamping grid over;

FIG. 2 shows a three dimensional view of the barbeque construction kit in another configuration, where the clamping grid is attached to a rotisserie motor mounted to the frame for continuous rotation of the clamping grid;

FIG. 3 shows a three dimensional view of the barbeque construction kit in a further configuration, where a rotisserie spit is attached to the rotisserie motor mounted to the frame for continuous rotation of the spit;

FIG. 4 shows a three dimensional view of the barbeque construction kit as shown in FIG. 3 with support legs being horizontally extended alongside the frame, such that the frame can be placed on top of an existing grid;

FIG. 5A shows a three dimensional view of the barbeque construction kit in another configuration, where a grid basket is attached to the rotisserie motor mounted to the frame for continuous rotation of the grid basket;

FIG. 5B shows a three dimensional view of the grid basket in FIG. 5A, the grid basket having two displaceable lids; and

FIG. 6 shows a three dimensional view of the barbeque construction kit in another configuration, where the clamping grid is attached to a manual flip-over device mounted to a circular frame.

In the drawings, like reference numerals denote like parts of the invention unless otherwise indicated.

### EMBODIMENT OF THE INVENTION

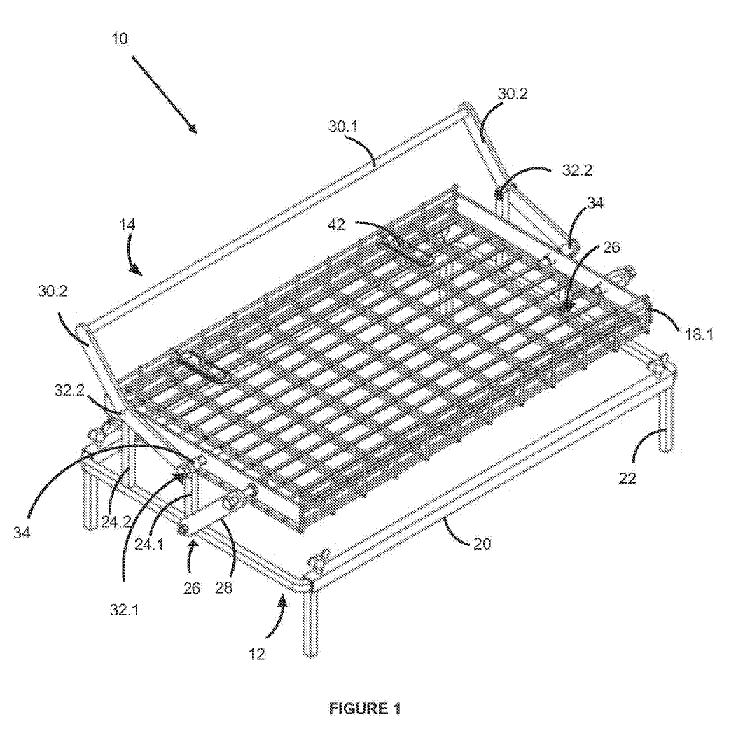

In FIG. 1 reference numeral (10) refers to a barbeque construction kit, assembled in different configurations to provide a barbeque suited for a specific cooking purpose.

The barbeque construction kit (10) includes a frame (12) for placing over a heat source, a manual grid flip-over device (14) mountable onto the frame (12), a rotisserie motor (16) mountable onto the frame (12) and three cooking accessories (18.1, 18.2, 18.3) interchangeably attachable to any one or both of the manual grid flip-over device (14) and rotisserie motor (16).

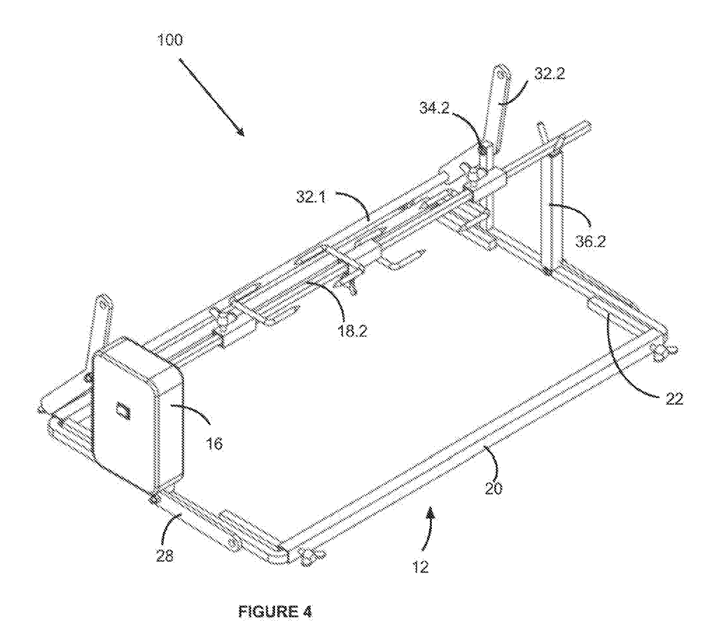

The frame (12) includes a main frame (20) which has a pair of horizontal support bars. The main frame (20) is made up of modular frame components enabling the frame (12) to be disassembled for storage. As shown in FIGS. 1 to 5, the main frame is in the form of a rectangular main frame. The frame (12) has four supporting legs (22) attachable to a bottom of the rectangular main frame (20) at its corners to elevate the rectangular main frame (20) over a heat source (not shown). As seen in FIGS. 1, 2, 3 and 5 the supporting legs (22) are in a first position and extended downwards from the rectangular main frame (20). In FIG. 4, the supporting legs (22) are in a second position and are extended horizontally alongside the rectangular main frame (20) such that the frame (12) can be placed directly on a heat source (not shown).

The frame (12) further includes upright supports (24) extending upwardly from the support bars of the main frame (20). In particular, the frame (12) includes a first and second pair of upright supports (24.1, 24.2), each pair including two supports positioned across from each other on opposed sides of the main frame (20). The first pair of upright supports (24.1) are positioned centrally on the support bars. The second pair of upright supports (24.2) are positioned off-centre between the first pair of upright supports (24.1) and an end of the support bars, on opposed sides of the main frame (20).

The main frame (20) has a pair of fastening formations (26) centrally on opposed ends of the main frame (20). The fastening formations (26) are in the form of apertures through the frame (12).

The manual grid flip-over device (14) includes a pair of pivot arms (28), one end of each pivot arm (28) being pivotably connectable to the fastening formations (26) on the main frame (20) and their opposed ends connectable to ends of the cooking accessory (18). The manual grid flip-over device (14) further includes a handle (30). The handle (30) is substantially U-shaped having a rear elongate bar (30.1) and two side bars (30.2). The rear elongate bar (30.1) is matched in length to the main frame (20) side. The two side bars (30.2) are V-shaped. The handle (30) has two pairs of attachment formations (32.1, 32.2), each pair including two attachment formations aligned with each other, on each of the side bars (30.2). The attachment formations (32.1, 32.2) are in the form of apertures through the side bars (30.2).

The first pair of attachment formations (32.1) are positioned at ends of the side bars (30.2) and are attachable with bolts to ends of the cooking accessory (18). The handle (30) has connection spacers (34) for connecting the first pair of attachment formations (32.1) to the cooking accessory (18). The cooking accessory includes a pair of rivnuts attached on opposed sides of the cooking accessory for connecting the handle to the cooking accessory. Advantageously, the rivnuts allow for easy attachment and detachment of the cooking accessory from the frame. In use, when the manual grid flip-over device (14) is connected to the frame (12), the connection spacers (34) rest on the first pair of upright supports (24.1) of the main frame (20).

The second pair of attachment formations (32.2) are positioned at the bends of the V-shaped side bars (30.2) and are attachable with bolts to the second pair of upright supports (24.2) of the main frame (20). In use, a user presses the handle (30) down and the pivot arms (28) move either forwardly or rearward to flip the attached cooking accessory (18) over.

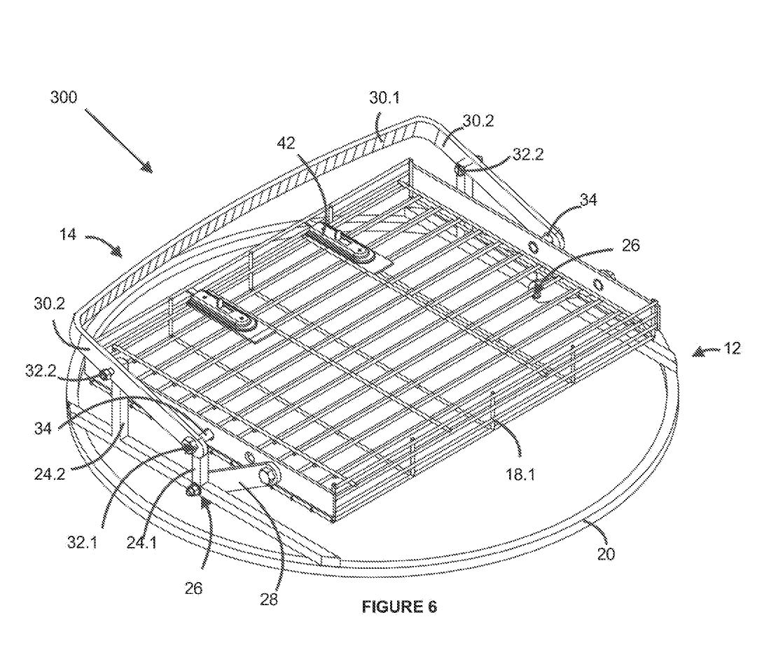

As shown in FIG. 6, the frame (12) includes a circular frame (20) which is shaped and dimensioned to fit a kettle barbeque. In this example, the handle (30) is substantially U-shaped having a rear elongate bar (30.1) and two straight side bars (30.2). The handle (30) is shaped and dimensioned to fit under a dome shaped lid of the kettle barbeque (not shown).

In FIG. 1, a first cooking accessory (18) in the form of a clamping grid (18.1) is used. The clamping grid (18.1) is defined by a shallow grid receptacle and a displaceable planar grid, the planar grid being adjustable to clamp varying sized portions of food to be cooked over the heat source within the shallow grid receptacle. The planar grid includes securing means (42) for securing the planar grid to the shallow grid receptacle. In this example the securing means (42) are in the form of latches. In this configuration the clamping grid (18.1) may be flipped over during cooking.

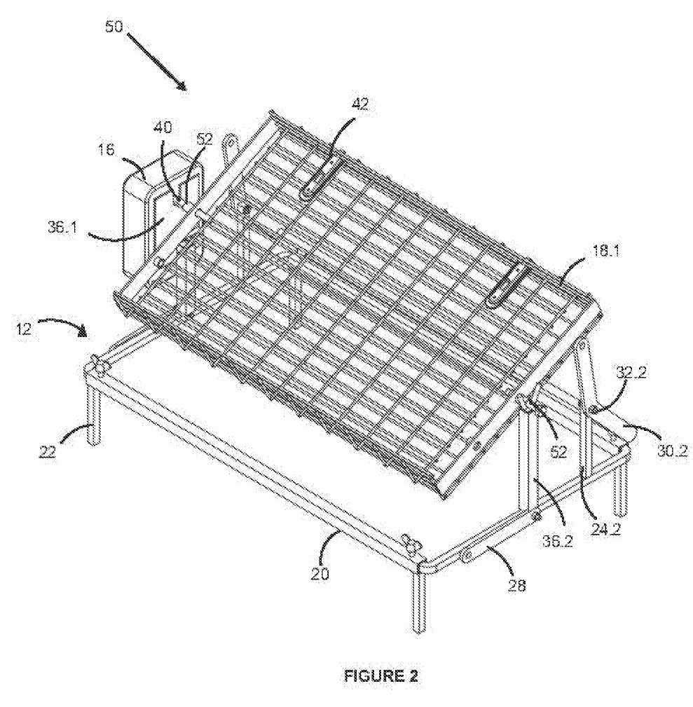

As shown in FIGS. 2 to 5 the frame (12) also includes support extenders (36) which are attachable to the upright supports (24.1) of the frame. The kit (10) includes two support extenders (36), in the form of shafts, which are slidably receivable onto the first pair of upright supports (24.1) of the frame (12).

The support extenders (36) comprise a first support extender (36.1) in the form of a motor mounting bracket and a second support extender (36.2) in the form of a V-shape rest.

The rotisserie motor (16) is mountable onto the motor mounting bracket (36.1). In this example the rotisserie motor (16) is in the form of a battery powered motor.

The cooking accessory (18) has a drive end (40) shaped and dimensioned to be received within the rotisserie motor (16), such that the cooking accessory (18) is driven by the motor (16), in particular, rotated by the motor.

The drive end (40) of the cooking accessory (18) is attachable to the rotisserie motor (16) and an opposed end rests on the V-shaped rest (36.2).

In FIG. 2, the manual flip-over device is disconnected from the clamping grid (18.1) and instead the motor mounting bracket (36.1) and V-shaped rest (36.2) are attached to the first pair of upright supports (24.1). The rotisserie motor (16) is attached to the motor mounting bracket (36.1) and the clamping grid (18.1) is attached to the rotisserie motor (16). The clamping grid (18.1) has a pair of elongate rotisserie fittings (52) centrally attachable on opposed ends of the clamping grid (18.1) for engaging with the support extenders (36). The pair of rotisserie fittings (52) includes at least one drive end for attaching to the rotisserie motor (16).

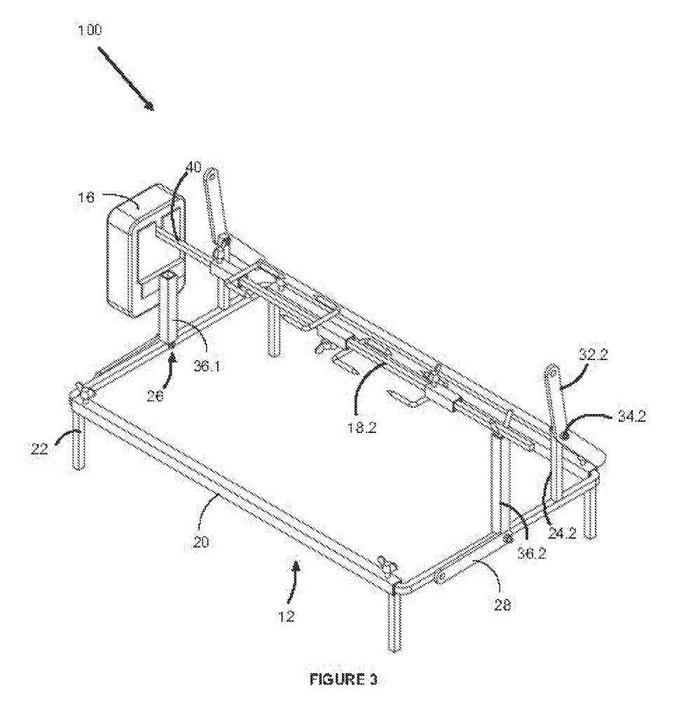

In the configuration shown in FIGS. 3 and 4, a second cooking accessory (18) is used, and is in the form of rotisserie spit (18.2). The rotisserie spit (18.2) includes an elongate rod having adjustable spit forks for receiving varying sized portions of food to be cooked over the heat source. The motor mounting bracket (36.1) and V-shaped rest (36.2) are attached to the first pair of upright supports (24.1). The rotisserie motor (16) is attached to the motor mounting bracket (38.1) and the rotisserie (18.2) is attached to the rotisserie motor (16).

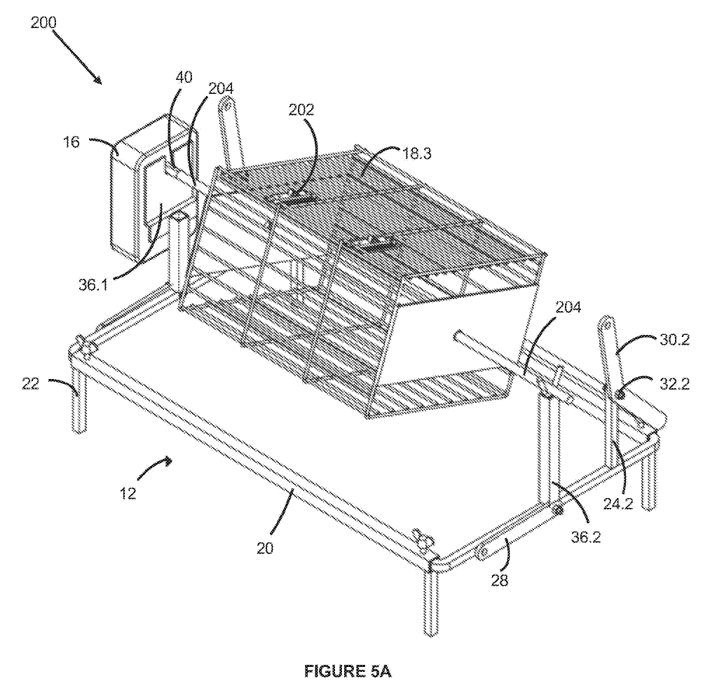

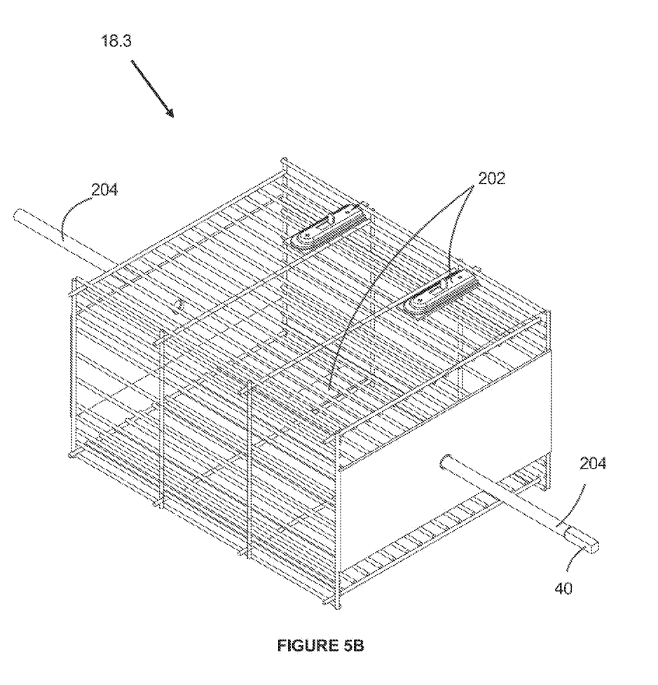

In FIG. 5A, a third cooking accessory (18.3) in the form of a grid basket is used. The grid basket (18.3) is defined by a large grid receptacle having a displaceable lid, the receptacle being shaped and dimensioned to receive larger portions of food to be cooked over the heat source. The displaceable lid is adjustable to balance the weight of food within the grid basket. The displaceable lid has fastening means (202) for enclosing food within the receptacle when it is in use. In this example the fastening means (202) are in the form of latches. The grid basket (18.3) has a pair of elongate rotisserie fittings (204) centrally attachable on opposed ends of the grid basket (18.3) for engaging with the support extenders (36). The pair of rotisserie fittings (204) includes at least one drive end for attaching to the rotisserie motor (16).

In FIG. 5B, the grid basket (18.3) is defined by a large grid receptacle having two displaceable lids.

In the configurations shown in FIGS. 2 to 5 the cooking accessory (18.1, 18.2, 18.3) is rotated over the heat source during cooking.

The inventor believes that the invention provides a new barbeque construction kit which enables a user to construct a barbeque suited for a specific cooking purpose using various cooking accessories.

1. A barbeque construction kit, which includes
a frame for placing over a heat source;
a manual grid flip-over device mountable onto the frame;
a rotisserie motor mountable onto the frame; and
at least one cooking accessory attachable to any one or both of the manual grid flip-over device and rotisserie motor.

2. The barbeque construction kit as claimed in claim 1, in which the frame includes a main frame having at least a pair of spaced apart horizontal support bars, parallel to each other.

3. The barbeque construction kit as claimed in claim 2, in which the main frame can be in the form of any one of a rectangular and circular frame.

4. The barbeque construction kit as claimed in claim 2, in which the frame includes a first and second pair of upright supports extending upwardly from the support bars of the main frame, each pair having two supports positioned across from each other on opposed sides of the main frame.

5. The barbeque construction kit as claimed in claim 4, in which the first pair of upright supports are positioned centrally on opposed sides of the support bars while the second pair of upright supports are positioned off-centre between the first pair of upright supports and ends of the support bars, on opposed sides of the main frame.

6. The barbeque construction kit as claimed in claim 5, in which the main frame includes a pair of fastening formations in the form of a fastening formation centrally on each of the horizontal support bars.

7. The barbeque construction kit as claimed in claim 6, in which the manual grid flip-over device includes a pair of pivot arms, one end of each pivot arm being pivotably connectable to the fastening formations on the main frame and their opposed ends connectable to ends of the cooking accessory.

8. The barbeque construction kit as claimed in claim 7, in which the manual grid flip-over device includes a handle that is substantially U-shaped, having a rear elongate bar and two side bars, the handle being attachable to the cooking device and main frame, such that in use, pushing down on the handle, moves the pivot arm and flips over the cooking accessory.

9. The barbeque construction kit as claimed in claim 8, in which the handle includes a first pair of attachment formations positioned at ends of the side bars being attachable to ends of the cooking accessory and a second pair of attachment formations positioned at the centre of the side bars being attachable to the second pair of upright supports of the main frame, each pair including two attachment formations aligned with each other, on each of the side bars.

10. The barbeque construction kit as claimed in claim 9, in which the handle includes connection spacers for connecting the first pair of attachment formations to the cooking accessory, the connection spacers resting on the first pair of upright supports when the manual grid flip-over device is connected to the frame.

11. The barbeque construction kit as claimed in claim 5, in which the frame includes support extenders defined by shafts which are slidably receivable onto the upright supports of the frame.

12. The barbeque construction kit as claimed in claim 11, in which the support extenders are in the form of a first and second support extender being attachable to the first pair of upright supports of the main frame.

13. The barbeque construction kit as claimed in claim 12, in which the first support extender is in the form of a motor mounting bracket and the second support extender is in the form of a V-shaped rest.

14. The barbeque construction kit as claimed in claim 13, in which the rotisserie motor is mountable onto the motor mounting bracket.

15. The barbeque construction kit as claimed in claim 1, in which the at least one cooking accessory includes a drive end shaped and dimensioned to be received within the rotisserie motor, such that the cooking accessory is rotated by the motor.

16. The barbeque construction kit as claimed in claim 1, in which the kit includes at least two cooking accessories which can be used interchangeably to construct a barbeque suited for a specific cooking purpose.

17. The barbeque construction kit as claimed in claim 16, in which the at least two cooking accessories include any two or more of a clamping grid, a rotisserie spit and a grid basket.
